(19) United States
(12) Patent Application Publication
(10) Pub. No.: US 2021/0377651 A1
(43) Pub. Date: Dec. 2, 2021

(54) 2-WAY TYPE MICROSPEAKER HAVING DRUM SAFETY FILTER STRUCTURE

(71) Applicant: BUJEON CO., LTD., Ansan-si (KR)

(72) Inventors: Minkoo PARK, Hwaseong-si (KR); Seungwoo CHUN, Hwaseong-si (KR)

(21) Appl. No.: 17/320,530

(22) Filed: May 14, 2021

(30) Foreign Application Priority Data
May 28, 2020 (KR) 10-2020-0064245
May 28, 2020 (KR) 10-2020-0064265

(51) Int. Cl. H04R 1/24; H04R 9/06; H04R 9/02; H04R 7/18; H04R 7/12; H04R 1/28; H04R 1/02; H04R 9/04

(52) U.S. Cl. CPC H04R 1/24; H04R 9/06; H04R 9/025; H04R 7/18; H04R 7/12; H04R 2201/029; H04R 1/023; H04R 1/025; H04R 9/045; H04R 2400/11; H04R 1/2826

(57) ABSTRACT

Disclosed herein is a 2-way type microspeaker having a drum safety filter (DSF) structure. The 2-way type microspeaker includes a woofer diaphragm, a first coil positioned between a central portion and boundary of the woofer diaphragm, a main magnet disposed inside the first coil, a sub-magnet installed outside the first coil, and a tweeter diaphragm disposed to face the woofer diaphragm. The microspeaker further includes a side support configured to support and surround the sub-magnet, and a first split support configured such that the upper portion thereof supports the rim of the woofer diaphragm and the lower portion thereof comes into contact with the top surface of the side support and also configured such that an open window of a predetermined size is formed such that high-pressure air can flow out.

### CROSS-REFERENCE TO RELATED APPLICATION

This application claims the benefit of Korean Patent Application Nos. 10-2020-0064245 and 10-2020-0064265 filed on May 28, 2020, which are hereby incorporated by reference herein in their entirety.

### BACKGROUND

### 1. Technical Field

The present invention relates to a 2-way type microspeaker having a drum safety filter (DSF) structure, and more particularly to a 2-way type microspeaker having a DSF structure capable of protecting the vibration drum part of the ear by effectively discharging high-pressure air formed inside the ear.

### 2. Description of the Related Art

A speaker uses a principle which is opposite to that of a microphone and in which an electrical signal is converted into a sound wave. A speaker is an electronic product in which, when a current enters a coil, a magnet turns into an electromagnet having its own magnetic field and vibrates the coil by using attractive and repulsive actions alternately pulling and pushing sound waves through contact with the surrounding constant magnetic field to make the diaphragm sound, thereby generating sound waves and outputting sound.

When an ear cap including the sound emission hole of the speaker is inserted into the ear canal of the ear, the ear is blocked from the outside except for the speaker, so that high pressure is generated in the ear canal and high-pressure air flows back into the speaker, thereby causing problems in that the volume emitted from the diaphragm is lowered and the sound quality is also deteriorated. A wearer is also likely to feel unpleasant, and there is a concern that long-term high pressure stimulates the drum part of the ear and impairs a sensitive function.

As a related art for solving this problem, Korean Utility Model Registration No. 20-0245053 discloses a structure for discharging high-pressure air by forming a vent hole in the outer periphery of the ear cap. Korean Patent No. 10-1863540 of the present applicant discloses a technology that directly forms a vent hole in the center of a diaphragm so that high-pressure air that has passed through the vent hole flows along both sides of the driver and is then discharged. Another Korean Patent No. 10-1958257 of the present applicant discloses a structure in which a sound emission hole is formed in the side of a driver rather than the front of the driver, so that the high-pressure air inside the ear flows in a lateral direction without changing its path along the top of a diaphragm and is then discharged. From a different point of view, for example, Korean Patent Publication No. 10-2019-5816 discloses a technology that directly adjusts air pressure by measuring the pressure inside the ear.

However, recently, a 2-way hybrid speaker that implements both woofer and tweeter functions at the same time has been developed. Accordingly, it is necessary to construct a DSF passage having a structure different from that of conventional 1-way speakers.

The present inventors have developed a microspeaker that can efficiently discharge high-pressure air inside the ear by taking into consideration the above-described environment.

### SUMMARY

Therefore, an object of the present invention is to provide a 2-way type microspeaker having a DSF structure capable of rapidly and efficiently inducing high-pressure air inside the ear and discharging it to the outside.

In order to accomplish the above object, the present invention provides a 2-way type microspeaker having a drum safety filter (DSF) structure, the 2-way type microspeaker including a woofer diaphragm, a first coil positioned between a central portion and boundary of the woofer diaphragm, a main magnet disposed inside the first coil, a sub-magnet installed outside the first coil, and a tweeter diaphragm disposed to face the woofer diaphragm, wherein the microspeaker further includes a side support configured to support and surround the sub-magnet, and a first split support configured such that the upper portion thereof supports the rim of the woofer diaphragm and the lower portion thereof comes into contact with the top surface of the side support and also configured such that an open window of a predetermined size is formed such that high-pressure air can flow out.

The microspeaker may further include a lower support configured to support the overall bottom surface of the main magnet and closely press the edge of the tweeter diaphragm, and the inner surface of the side support is spaced apart from the outer end of the lower support by a predetermined distance to provide an inlet hole for high-pressure air.

The microspeaker may further include a second split support having an open window of a predetermined size so that high-pressure air introduced through the inlet hole flows into a space between the main magnet and the sub-magnet.

A first ventilation volume control mesh may be installed at an end of a space, formed by the first split support, to allow air to flow therethrough.

In order to accomplish the above object, the present invention provides a 2-way type microspeaker having a drum safety filter (DSF) structure, the 2-way type microspeaker including a woofer diaphragm, a first coil positioned between a central portion and boundary of the woofer diaphragm, a main magnet disposed inside the first coil, a sub-magnet installed outside the first coil, and a tweeter diaphragm disposed to face the woofer diaphragm, wherein the microspeaker further includes a lower support configured to closely press the edge of the tweeter diaphragm, a side plate configured to press the sub-magnet while surrounding the outer surface of the sub-magnet, and an outer casing installed such that the side surface thereof is spaced apart from the side plate and configured such that the end of a bottom thereof bent inside is spaced apart from the outer surface of the lower support and forms an inlet hole of a predetermined size through which high-pressure air is introduced.

A third split support may be installed to occupy at least part of a space between the inner side of the outer casing and the outer side of the side plate while closely surrounding the side plate from the outside, thereby providing a channel through which high-pressure air entered through the inlet hole, an outlet hole of a predetermined size may be formed in the side of the outer casing, and the outlet hole may be covered with a third ventilation air amount control mesh.

The microspeaker may further include an upper housing and an ear cap coupled to the upper housing and configured to provide a sound emission hole, an outflow hole communicating with an outside may be formed in one side of the upper housing, and a second ventilation air amount control mesh may be installed to cover the outflow hole.

The microspeaker may further include an upper housing and an ear cap coupled to the upper housing and configured to provide a sound emission hole, and a woofer grill configured to divide a space of the upper housing and provide a space for mounting hardware may be injection-molded to be integrated with a bottom of the upper housing.

In order to accomplish the above object, the present invention provides a 2-way type microspeaker having a drum safety filter (DSF) structure, the 2-way type microspeaker including a woofer diaphragm, a first coil positioned between a central portion and boundary of the woofer diaphragm, a main magnet disposed inside the first coil, a sub-magnet installed outside the first coil, and a tweeter diaphragm disposed to face the woofer diaphragm, wherein the 2-way type microspeaker has an appearance formed by an upper casing configured to cover the top of a driver and a lower casing configured to cover the rest of the structure, a woofer diaphragm having a pressed rim is installed between the side rim of the upper casing and an auxiliary ring, a cylindrical lower coil is disposed upward between the central portion and boundary portion of the tweeter diaphragm, and the 2-way type microspeaker further includes a central support configured such that the top surface thereof comes into contact with an upper part of the main magnet, the center thereof is formed in an empty cylindrical shape, extends downward, and is accommodated inside the lower coil, and the top of the cylinder is covered with a mesh, and a lower support configured to support the bottom surface of the main magnet and also configured such that the outer surface thereof comes into contact with and closes the tweeter diaphragm.

The 2-way type microspeaker may further include first and second side supports configured to be successively installed to come into contact with the bottom surface of the lower support plate installed under the woofer diaphragm, a third side support configured to come into contact with the inner side of the top surface of the sub-magnet, a fourth side support configured to be adjacent to the third side support and extend downward to cover all the remaining outside of the top surface of the sub-magnet and the side surface of the sub-magnet, and a fifth side support configured such that the top surface thereof comes into contact with the bottom surface of the sub-magnet and the bottom surface thereof comes into contact with the bent bottom surface of the lower casing while covering the outer surface of the lower support.

The second side support, the fourth side support, and the fifth side support may be installed to be spaced apart from the lower casing, and at least the fifth side support may be installed to provide a passage by being spaced apart from a center line in the longitudinal direction of a section at a fine interval.

The 2-way type microspeaker may further include a support casing configured to press and support the outer surface of the side support, the support casing may include a side surface extending vertically and an upper surface extending outward so as to come into contact with the inner surface of the ear cap from the upper end of the side surface, and an external vent hole configured to discharge high-pressure air may be formed in the top surface of the support casing.

A ventilation block having a predetermined volume may be further formed on the inner side of the ear cap, the ventilation block may include a block side surface extending upward to come into contact with and support the side surface of the support casing under the ear cap, and a block top surface horizontally extending to come into contact with and support the top surface of the support casing from a bottom surface at the upper end of the block side surface, and a block identical to the former block may be also installed on the opposite side at a predetermined interval from a center line in a longitudinal direction to provide a path through which high-pressure air flows through an overall cut surface.

A fourth ventilation air amount control mesh may be installed over the outer vent hole.

In order to accomplish the above object, the present invention provides a 2-way type microspeaker having a drum safety filter (DSF) structure, the 2-way type microspeaker including a woofer diaphragm, a first coil positioned between a central portion and boundary of the woofer diaphragm, a main magnet disposed inside the first coil, a sub-magnet installed outside the first coil, and a tweeter diaphragm disposed to face the woofer diaphragm, wherein a block having a side surface extending upward while pressing the sub-magnet from the outside and a top surface continuing to extend outward from the top of the side surface up to the inner surface of the ear cap is installed, and a ventilation channel configured to penetrate the overall height of the block and communicate to the top surface is formed inside the block.

### BRIEF DESCRIPTION OF THE DRAWINGS

The above and other objects, features, and advantages of the present invention will be more clearly understood from the following detailed description taken in conjunction with the accompanying drawings, in which:

FIG. 1 is a perspective sectional view of a microspeaker according to a first embodiment of the present invention taken along the center line thereof in the longitudinal direction thereof;

FIG. 2 is a front view of FIG. 1;

FIG. 3 is a front view of the microspeaker of FIG. 1, in which an upper housing and an ear cap are combined with each other, taken along the center line thereof in the longitudinal direction thereof;

FIG. 4 is a perspective sectional view of a microspeaker according to a second embodiment of the present invention taken along the center line thereof in the longitudinal direction thereof;

FIG. 5 is a front view of FIG. 4;

FIG. 6 is a front view of the microspeaker of FIG. 4, in which an upper housing and an ear cap are combined with each other, taken along the center line thereof in the longitudinal direction thereof;

FIG. 7 is a perspective sectional view of the microspeaker according to the first embodiment of the present invention taken along the center line thereof in the longitudinal direction thereof, which illustrates a woofer grill;

FIG. 8 is a front view of FIG. 7;

FIG. 9 is a front sectional view of the microspeaker of FIG. 7, in which an upper housing and an ear cap are combined with each other, taken along the center line thereof in the longitudinal direction thereof;

FIG. 10 is a front sectional view of a microspeaker 1 according to another embodiment of the present invention taken along the center line thereof in the longitudinal direction thereof;

FIG. 11 is a perspective sectional view of a microspeaker according to a fourth embodiment of the present invention taken along the center line thereof in the longitudinal direction thereof;

FIG. 12 is a front view of FIG. 11;

FIG. 13 is a front sectional view of the microspeaker of FIG. 11, in which an upper housing and an ear cap are combined with each other, taken along the center line thereof in the longitudinal direction thereof;

FIG. 14 is a perspective sectional view of a microspeaker according to a fifth embodiment of the present invention taken along the center line thereof in the longitudinal direction thereof;

FIG. 15 is a front view of FIG. 14; and

FIG. 16 is a front sectional view of the microspeaker according to the fifth embodiment of the present invention, in which an upper housing and an ear cap are combined with each other, taken along the center line thereof in the longitudinal direction thereof.

### DETAILED DESCRIPTION

Objects and effects of the present invention, and technical configurations for achieving them will become apparent with reference to the embodiments described later in detail together with the accompanying drawings. In the following description of the present invention, when it is determined that a detailed description of a known function or configuration may unnecessarily obscure the subject matter of the present invention, a detailed description thereof will be omitted.

Throughout the specification, when a part is described as “including” a component, it means that other components may be further included rather than being excluded unless specifically stated to the contrary. Meanwhile, in the embodiments of the present invention, each component, functional block or mean may include one or more sub-components.

A drum safety filter (DSF) structure for a microspeaker according to the present invention will be described below with reference to the accompanying drawings. The DSF structure for a microspeaker 1 according to the present invention is characterized in that high-pressure air is discharged using the inner or outer space of a driver. Both cases will be described.

### First Embodiment

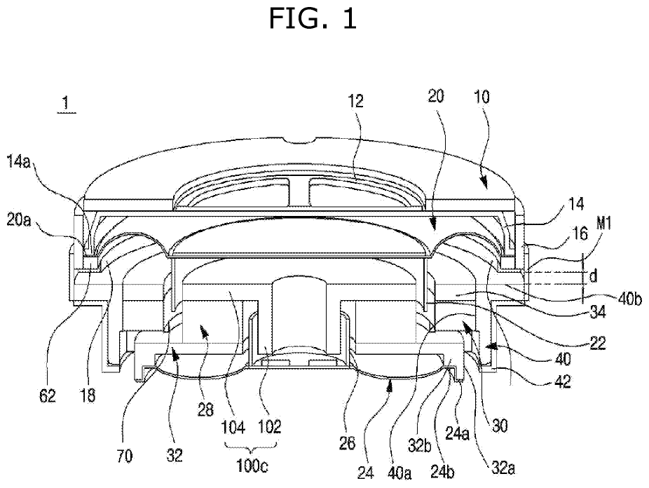

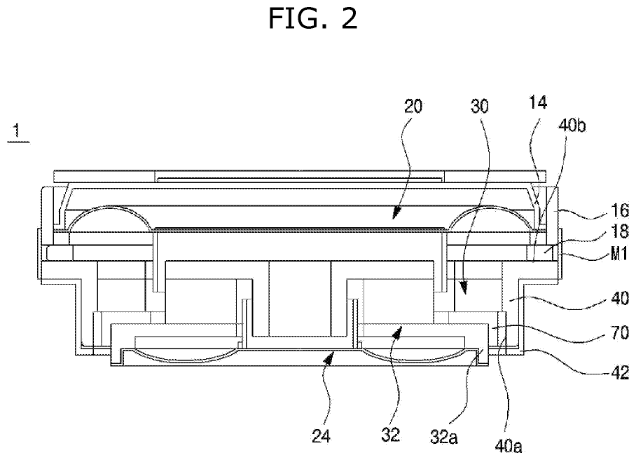

FIG. 1 is a perspective sectional view of the microspeaker 1 of the present invention taken along the center line thereof in the longitudinal direction, and FIG. 2 is a front view of FIG. 1.

The microspeaker 1 of the present invention is a 2-way hybrid type. A woofer diaphragm 20 is disposed in the upper part of the microspeaker 1, and a tweeter diaphragm 24 is disposed in the lower part thereof. Sound is emitted through the bottom of the tweeter diaphragm 24.

A disk-shaped cover 10 in which a circular hole 12 is formed in the center thereof is positioned on the top of the microspeaker 1. Based on the woofer diaphragm 20, an upper support plate 14 is positioned over the woofer diaphragm 20, and a support ring 62 is positioned beneath the woofer diaphragm 20. The upper support plate 14 covers the overall woofer diaphragm 20, the periphery of the upper support plate 14 extends downward, and a rim 14a extending horizontally from the lower end of the periphery of the upper support plate 14 presses and compresses a rim 20a, surrounding the relatively outer dome-shaped portion the woofer diaphragm 20 and located outside, from the top. The support ring 62 presses and compresses the rim 20a from the bottom. An annular band-shaped protective plate 16 is installed to extend to the bottom surface of the cover 10 while surrounding the outer surfaces of the support ring 62 and the upper support plate 14. In this manner, since the woofer diaphragm 20 is firmly supported and closed by several members, water or high-pressure air from the ear does not leak out through the outer part of the woofer diaphragm 20 as well as the center of the woofer diaphragm 20.

A first split support 18 supporting the support ring 62 from the bottom surface of the support ring 62 is installed in a semi-ring shape. The first split support 18 is installed such that there is a gap d with respect to the center line in the longitudinal direction, as shown in FIG. 1. Since a first split support 18 having the same structure is also installed on the opposite side (not shown), a space or an open window that is twice the size of the distance d as a whole is provided. Then, high-pressure air flows through this space and is discharged.

A first coil 22 is installed at the boundary of the woofer diaphragm 20. A main magnet 28 is disposed inside the first coil 22, and a sub-magnet 30 is disposed outside the first coil 22. An upper plate 34 is installed over the sub-magnet 30.

Based on the tweeter diaphragm 24, a second coil 26 is installed to extend upward from the boundary of the tweeter diaphragm 24.

The microspeaker 1 of the present invention includes a main body 104 configured to support the top surface of the main magnet 28 and a central support 100c including a column 102 which extends downward from the center of the main body 104 and is disposed inside the second coil 26.

The outer edge of the tweeter diaphragm 24 that is positioned outside around the relatively outer dome-shaped portion is bent twice, so that a first edge 24a positioned outside in a plan view and a second edge 24b positioned inside the first edge 24a are provided. The outer surface of the microspeaker 1 of the present invention Micro speaker 1 of the present invention is bent twice while supporting the overall bottom surface of the main magnet 28, thereby providing a lower support 32 having a first edge portion 32a positioned outside in a plan view and a second edge portion 32b positioned inside the first edge portion 32a. Each edge of the tweeter diaphragm 24 is pressed and brought into close contact by each edge portion of the lower support. Accordingly, as previously described in connection with the woofer diaphragm 20, the tweeter diaphragm 24 also has a structure in which water or high-pressure air does not leak in or out through the outer portion thereof as well as the center portion thereof.

In the present invention, a side support 40 is installed such that the top surface 40b thereof comes into contact with the first split support 18, and the inner surface 40a thereof extends downward while being in contact with the sub-magnet 30 and the upper plate 34 and is spaced apart from the outer end of the lower support 32 by a predetermined distance, thereby providing an inlet hole, as shown in FIG. 2. Since both ends of the rim of the tweeter diaphragm 24 are located inside the outer surface of the sub-magnet 30, it can be considered that the inlet hole is naturally provided. Reference numeral 42 is a support casing configured to support the side support 40 from the outside.

In the present invention, as shown in FIG. 2, a second split support 70 is installed in a semi-ring shape between the bottom surface of the sub-magnet 30 and the bottom surface of the lower support 32. Like the first split support 18, a second split support 70 is also installed such that a predetermined distance is present with respect to the center line in the longitudinal direction. Since a second split support 70 having the same structure is also installed on the opposite side (not shown), a space or an open window that is twice the size as a whole is provided. In addition, high-pressure air that has been introduced through the inlet hole between the lower support 32 and the side support 40 flows upward through this space. If the second split support 70 is in the form of a continuous ring or plate that is not separated like other members, it will be appreciated that even when air enters through the inlet hole, it cannot flow upward.

In the present invention, the lower end of a protective plate 16 does not extend to the first split support 18. Accordingly, a space corresponding to the height of the first split support 18 is formed in connection with the top surface of the side support 40. Outside this space, a first ventilation air amount control mesh M1 capable of the outflow of air is installed.

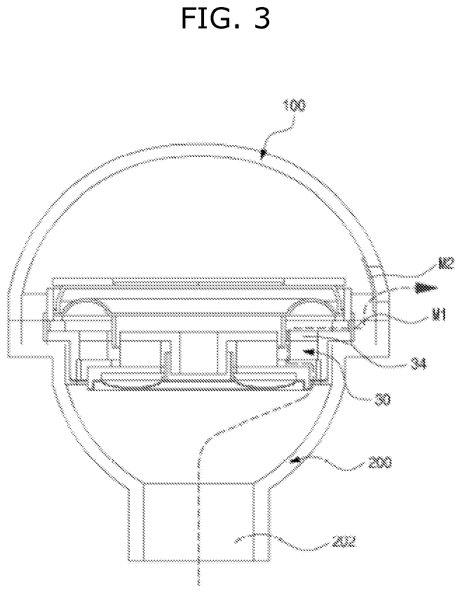

FIG. 3 is a front sectional view of the microspeaker 1 of the present invention, in which the upper housing 100 and the ear cap 200 are combined with each other, taken along the center line in the longitudinal direction. A sound emission hole 202 is formed in the center of the bottom of the ear cap 200. An outlet hole communicating with the outside is formed in one side of the upper housing 100, and a ventilation air amount control mesh M2 is installed to cover the outlet hole.

Based on the above description, the outflow path of the high-pressure air formed in the ear will be described with reference to FIG. 3 as follows:

The air introduced through the sound emission hole 202 of the ear cap 200 enters through the hole between the side support 40 and the lower support 32, flows through the space provided by the second split support 70, moves upward through the space between the main magnet 28 and the sub-magnet 30, and is collected. In addition, the air is passed through the first ventilation air amount control mesh M1 along the path provided by the first split support 18, and is discharged to the outside through the second ventilation air amount control mesh M2 of the upper housing 100.

### Second Embodiment

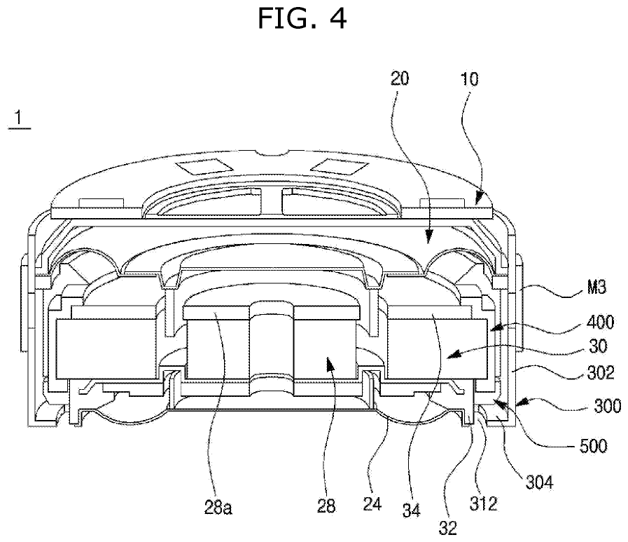

Next, a DSF structure for a microspeaker according to a second embodiment of the present invention will be described with reference to FIGS. 4 to 6.

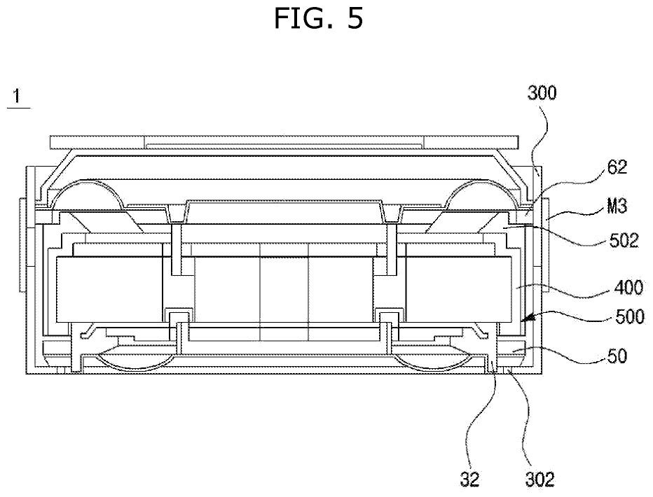

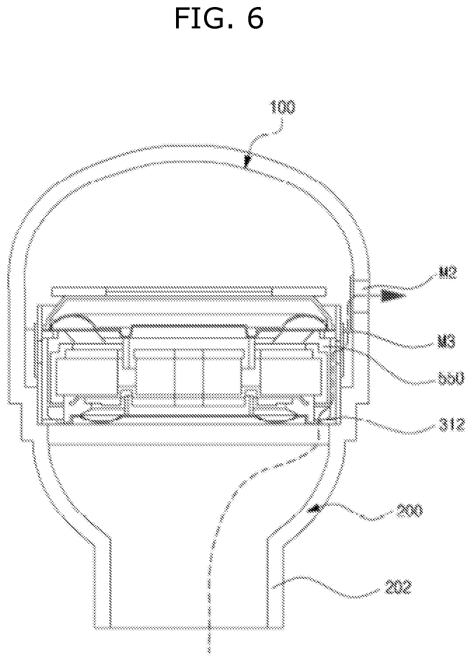

FIG. 4 is a perspective sectional view of the microspeaker 1 of the present invention taken along the center line thereof in the longitudinal direction thereof, FIG. 5 is a front view of FIG. 4, and FIG. 6 is a front view of the microspeaker 1 of the present invention, in which an upper housing 100 and an ear cap 200 are combined with each other, taken along the center line thereof in the longitudinal direction thereof.

The second embodiment differs from the previous embodiment in that high-pressure air is discharged outside a driver without passing through the inside of the driver. The top surface of a main magnet 28 is supported by a main upper plate 28a, and the central support 100c is not present. The heights of the main magnet 28 and a sub-magnet 30 are the same, so that a height for the installation of the second split support 70 is insufficient unlike in the first embodiment. If the space is forcibly formed, the volume of the speaker will be excessively increased. In this structure, it is reasonable to discharge high-pressure air outside the driver.

Accordingly, in the second embodiment of the present invention, the lower support 32 seals the rim of the tweeter diaphragm 24. The side plate 400 surrounds and seals the outer surfaces of the sub magnet 30 and the upper plate 34. Therefore, high-pressure air cannot enter the inside of the driver.

A large column-type outer casing 300 is installed to surround the overall outer surface of the microspeaker 1. The outer casing 300 is installed such that the side 302 thereof is spaced apart from a side plate 400, and the end of a bottom surface 304 bent inward is spaced apart from the outer surface of the lower support body 32 and forms an inflow hole 312 of a predetermined size. An outlet hole of a predetermined size is formed in the side surface 302, and the outlet hole is covered with a third ventilation air amount control mesh M3.

However, since this structure alone has a limitation in rapidly discharging high-pressure air, the present invention further provides a third split support 500. The third split support 500 is installed to come into close contact with the outer surface of the side plate 400 and thus occupy at least a portion of the space between the inner surface of the outer casing 300 and the outer surface of the side plate 400 while surrounding the side plate 400. The third split support 500 is installed such that a predetermined distance is present with respect to the center line in the longitudinal direction, like the first and second split supports 18 and 70, and provides a narrow channel through which high-pressure air flows. An upper portion 502 having a thick portion on the third split support 500 closes the space between the top surface of the side plate 400 and the support ring 62, thereby preventing high-pressure air from flowing through the empty gap in the upper portion and also supporting the woofer diaphragm 20 more firmly.

Based on the above description, the outlet path of the high-pressure air formed in the ear will be described with reference to FIG. 6. The air introduced through the sound emission hole 202 of the ear cap 200 enters through the inlet hole 312, flows through a long channel provided by the third split support 500 in the height direction, and is discharged to the outside through the third ventilation air amount control mesh M3 of the outer casing 300.

The DSF structure of the second embodiment of the present invention may be appropriately modified and then applied to any internal structures of drivers in addition to those disclosed in the drawings.

<Installation Structure for Woofer Grill>

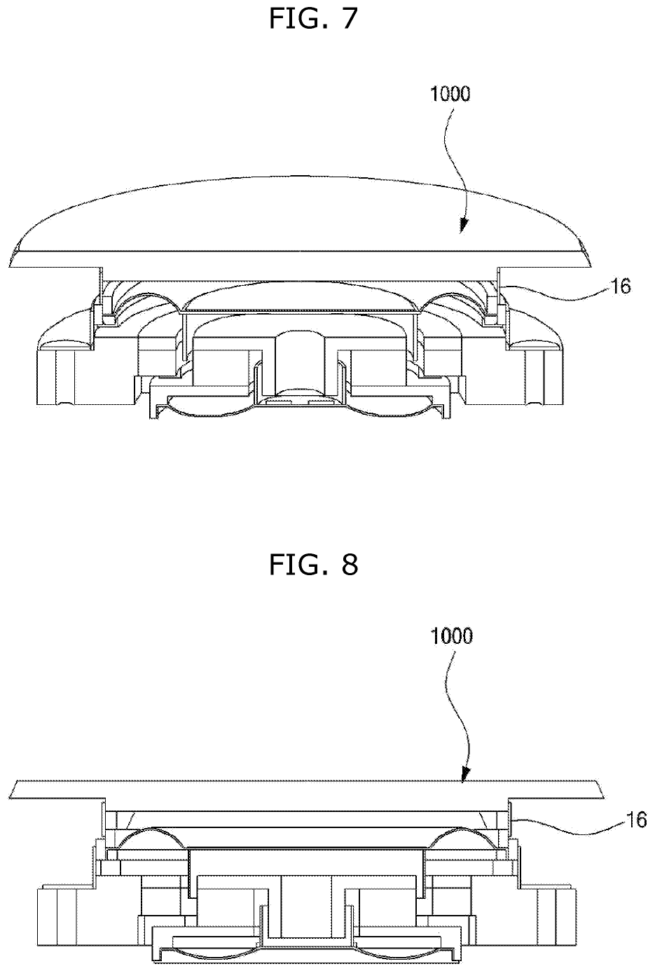

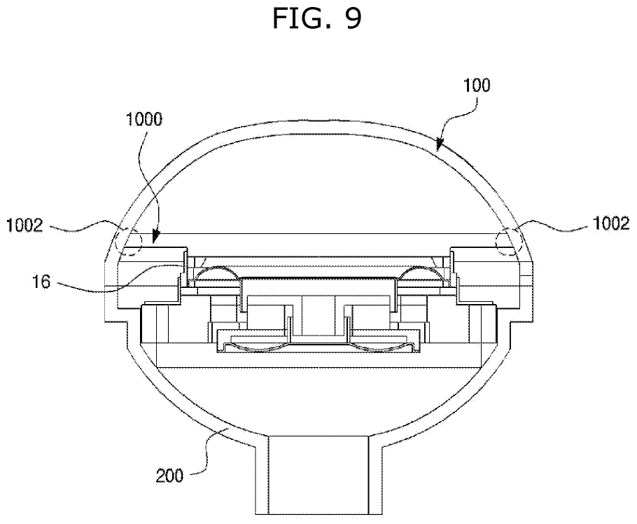

Next, an installation structure for a woofer grill 1000 applicable to all embodiments of the present invention will be described with reference to FIGS. 7 to 9 based on the first embodiment.

Referring to these drawings together, the woofer grill 1000 is installed under the upper housing 100 to divide the space of the upper housing 100 while closely supporting the protection plate 16 from above, so that a considerably wide space is provided between the top surface and the upper housing 100. In this space, hardware components such as a Bluetooth battery and a PCB are mounted, so that the microspeaker 1 can be made to have high-density and compactness.

A joint portion 1002 where the woofer grill 1000 comes into contact with the upper housing 100 is formed to be hermetically sealed. To this end, it is desirable that, although a method of caulking or bonding may be used, the woofer grill 1000 is injection-molded together with the internal parts of the microspeaker 1 such as the upper housing 100 or the protective plate 16 in an integrated manner. The sealing structure of the woofer grill 1000 contributes to the function of preventing moisture such as water from penetrating into hardware such as a Bluetooth battery and a PCB.

In particular, the woofer grill 1000 is helpful in allowing high-pressure air to be rapidly discharged through the outlet hole of the upper housing 100 without to enter above the woofer grill 1000 and diffusing in relation to the above-described embodiment of the present invention.

### Third Embodiment

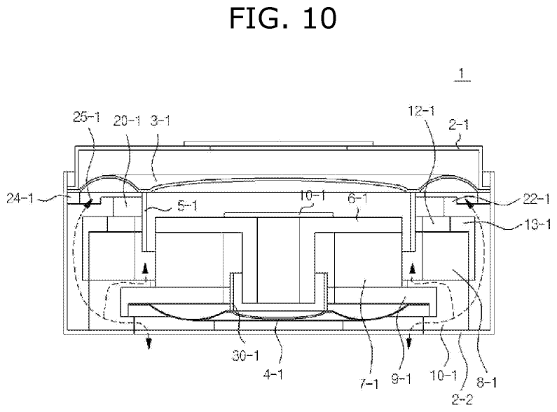

Next, FIG. 10 is a sectional view of a microspeaker 1 according to another embodiment of the present invention.

The microspeaker 1 has an external appearance that is defined by an upper casing 2-1 configured to cover the top portion of a driver and a lower casing 2-2 configured to cover most of the rest of the structure. A woofer diaphragm 3-1 having a pressed edge is installed between the side edge of the upper casing 2-1 and an auxiliary ring 24-1.

A cylindrical upper coil 5-1 is disposed downward between the central and side portions of the woofer diaphragm 3-1. A tweeter diaphragm 4-1 is installed adjacent to a sound emission outlet while facing the woofer diaphragm 3-1, and a cylindrical lower coil 30-1 is disposed upward between the center and side portions of the tweeter diaphragm 4-1. A main magnet 7-1 is mounted inside the space formed by the upper and lower coils 5-1 and 30-1, and a sub-magnet 8-1 is disposed outside the upper coil 5-1.

In the present invention, a central support 6-1 is configured such that the top surface thereof comes into contact with the top portion of the main magnet 7-1 and the center thereof extends downward in a hollow cylindrical shape and is accommodated inside the lower coil 30-1. The top surface of the cylinder is covered with a mesh 10-1.

In the present invention, the lower support 9-1 supports the bottom surface of the main magnet 7-1, and the outer surface thereof comes into contact with the tweeter diaphragm 4-1 and closes it.

In the present invention, side supports include first and second side supports 20-1 and 22-1, third and fourth side supports 12-1 and 13-1, and a fifth side support 10-1 from the top. The first and second side supports 20-1 and 22-1 are successively installed to come into contact with the bottom surface of the lower support plate 25-1 installed under the woofer diaphragm 301. The third side support 12-1 comes into contact with the inner side of the top surface of the sub-magnet 8-1, and the fourth side support 13-1 is adjacent to the third side support 12-1 and extends downward to cover all the remaining outside of the top surface of the sub-magnet 8-1 and the side surface of the sub-magnet 8-1. The fifth side support 10-1 is configured such that the top surface thereof comes into contact with the bottom surface of the sub-magnet 8-1 and the bottom surface thereof comes into contact with the bent bottom surface of the lower casing 2-2 while covering the outer surface of the lower support 9-1.

Referring to the structure of the side support and the lower casing 2-2, the second side support 22-1, the fourth side support 13-1, and the fifth side support 10-1 are installed to be spaced apart from the lower casing 2-2. Accordingly, as indicated by the arrows, passages through which the vibration sound of a woofer is transmitted to the lower portion or the high-pressure air formed in the ear canal flows to the upper portion is formed.

In addition, at least the fifth side support 10-1 is installed to be spaced apart from the center line in the longitudinal direction of the cross section at a fine interval, i.e., to provide passages. Therefore, as indicated by the arrows, radiated sound transmission and ventilation passage are formed between the main magnet 7-1 and the sub-magnet 8-1.

### Fourth Embodiment

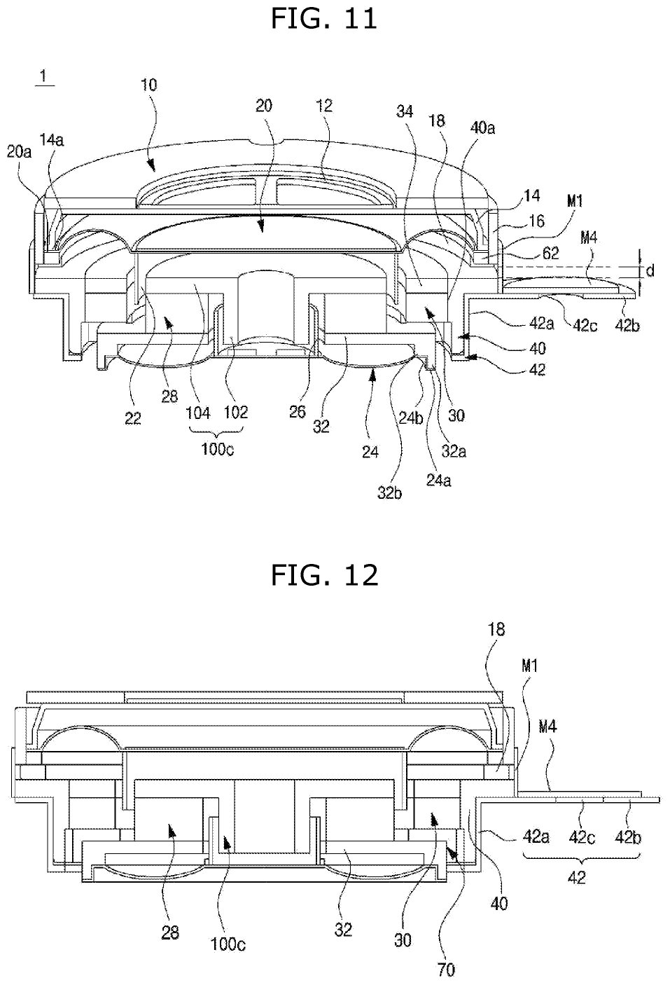

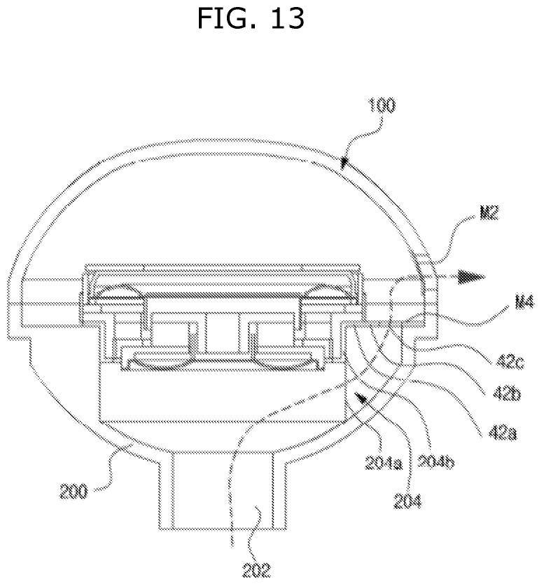

The fourth embodiment of the present invention has the same overall structure as the first embodiment, but a support casing 42 supports the overall outer surface of a side support 40 by pressing it, as shown in FIGS. 11 and 12. The support casing 42 includes a side surface 42a extending vertically and having a lower end bent inward, and a top surface 42b extending horizontally from the upper end of the side surface 42a to the outside. As shown in FIG. 13, the top surface 42b extends beyond the first ventilation air amount control mesh M1 to the stepped surface of the ear cap 200, and an external vent hole 42c is located beyond a microspeaker inner module. A fourth ventilation air amount control mesh M4 is installed over the outer vent hole 42c.

A ventilation block 204 having a predetermined volume is formed inside the ear cap 200 of the present invention. The block 204 includes a side surface 204a extending upward to come into contact with the side surface 42a under an ear cap 200 and support the side surface 42a, and a top surface 204b extending horizontally to come into contact with the top surface 42b from the bottom surface at the upper end of the side surface 204a and support the top surface 42b. The block 204 is also located at an interval from the center line in the longitudinal direction like the first split support 18, and a block 204 having the same structure is also installed on the opposite side (not shown), so that the overall front surface of the block 204 provides a passage through which high-pressure air flows.

Therefore, the air introduced through the sound emission hole 202 of the ear cap 200 passes through the split space of the block 204 providing a relatively wide channel, accelerates while passing through the external vent hole 42c having a relatively narrow diameter, is diffused (Bernoulli's Law), and is then discharged to the outside through the second ventilation air amount control mesh M2 of the upper housing 100.

Although the above-described module external high-pressure air outlet structure of the present invention is installed as in the embodiment described with reference to FIGS. 11 to 13 and provides various outlet passages for high-pressure air, it is obvious that it may also be applied to other suitable variants that do not provide any outlet passage for high-pressure air inside the module.

In addition, a ventilation block 204 may be manufactured to be integrated with the ear cap 200, or may be provided as a separate component.

### Fifth Embodiment

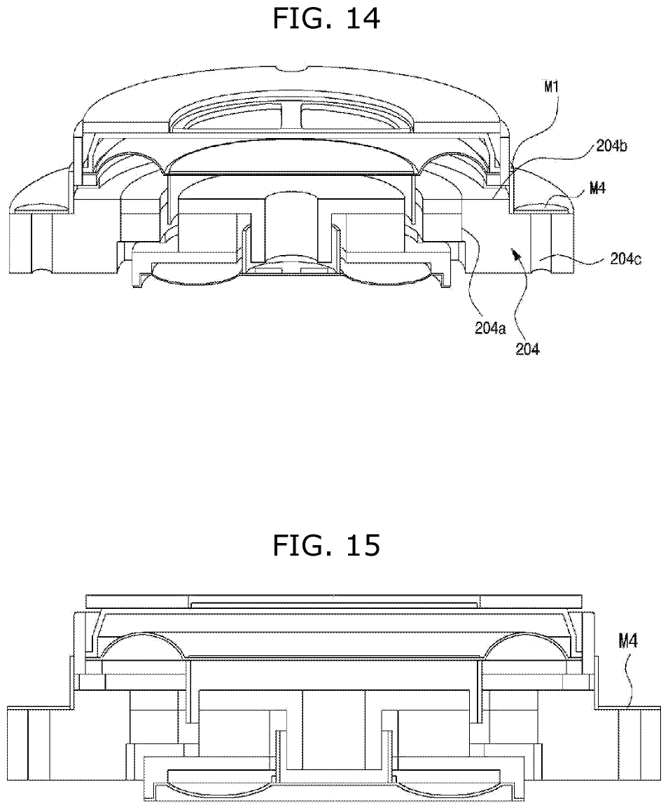

Next, a DSF structure for a microspeaker according to a fifth embodiment of the present invention will be described with reference to FIGS. 14 to 16.

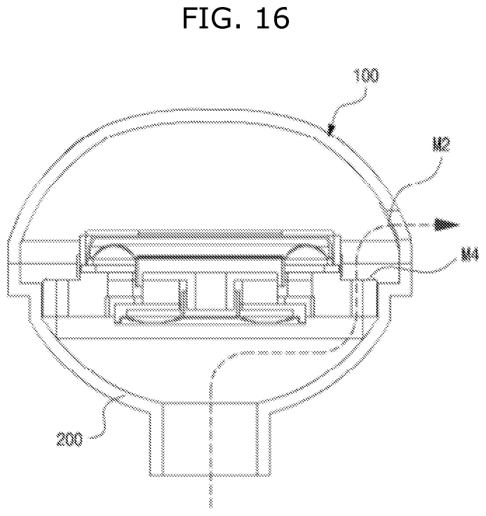

FIG. 14 is a perspective sectional view of the microspeaker 1 according to the fifth embodiment of the present invention taken along the center line thereof in the longitudinal direction thereof, FIG. 15 is a front view of FIG. 14, and FIG. 16 is a front sectional view of the microspeaker 1 according to the fifth embodiment of the present invention, in which an upper housing 100 and an ear cap 200 are combined with each other, taken along the center line thereof in the longitudinal direction thereof.

The fifth embodiment differs from the previous embodiments in that the side support 40 and the support casing 42 are eliminated and a block 204 installed on an ear cap 200 is extended to the inside of a driver module and takes over the role of the drive module. In other words, the side surface 204a of the block 204 is extended while pressing a sub-magnet 30 and an upper plate 34 from the outside, and the top surface 204b of the block 204 continues to extend outward from the upper end of the side surface 204a to come into airtight contact with the stepped surface of the ear cap 200. A ventilation channel 204c that penetrates the entire height of the block 204 and communicates up to a portion of the top surface 204b occupying an area beyond the first ventilation air amount control mesh M1 is formed in the block 204. A fourth ventilation air amount control mesh M4 is installed over the upper opening of the ventilation channel 204c.

The block 204 of the fifth embodiment is not split and installed at an interval, unlike that of the first embodiment. The reason for this is that a ventilation channel 204c is present inside a body.

In the fifth embodiment of the present invention, the air introduced through the sound emission hole 202 of the ear cap 200 passes through the ventilation channel 204c, which is a relatively narrow flow passage, exits, diffuses, and is then discharged to the outside through the ventilation air amount control mesh M2.

Although the above-described module external high-pressure air outlet structure of the present invention may be installed as in the embodiment described with reference to FIGS. 14 to 16 and provide various outlet passages for high-pressure air, it is obvious that it may also be applied to other suitable variants that do not provide any outlet passage for high-pressure air inside the module.

The present invention has the advantage of providing the 2-way microspeaker having the DSF structure that can rapidly and smoothly discharge high-pressure air from the ear.

The present invention has the advantage of providing the 2-way microspeaker having the DSF structure that induces high-pressure air not only to the inside of the driver but also to the outside.

According to the present invention, it is possible to improve the quality, performance and marketability of a speaker and provide a pleasant atmosphere to a user.

The above-described embodiments are merely illustrative of the technical spirit of the present invention, and it will be appreciated by those of ordinary skill in the art to which the present invention pertains that various modifications and alterations may made to the embodiments without departing from the essential characteristics of the present invention.

What is claimed is:

1. A 2-way type microspeaker having a drum safety filter (DSF) structure, the 2-way type microspeaker comprising a woofer diaphragm, a first coil positioned between a central portion and boundary of the woofer diaphragm, a main magnet disposed inside the first coil, a sub-magnet installed outside the first coil, and a tweeter diaphragm disposed to face the woofer diaphragm, wherein the microspeaker further comprises a side support configured to support and surround the sub-magnet, and a first split support configured such that an upper portion thereof supports a rim of the woofer diaphragm and a lower portion thereof comes into contact with a top surface of the side support and also configured such that an open window of a predetermined size is formed such that high-pressure air can flow out.

2. The 2-way type microspeaker of claim 1, wherein the microspeaker further comprises a lower support configured to support an overall bottom surface of the main magnet and closely press an edge of the tweeter diaphragm, and an inner surface of the side support is spaced apart from an outer end of the lower support by a predetermined distance to provide an inlet hole for high-pressure air.

3. The 2-way type microspeaker of claim 2, wherein the microspeaker further comprises a second split support having an open window of a predetermined size so that high-pressure air introduced through the inlet hole flows into a space between the main magnet and the sub-magnet.

4. The 2-way type microspeaker of claim 3, wherein a first ventilation volume control mesh is installed at an end of a space, formed by the first split support, to allow air to flow therethrough.

5. A 2-way type microspeaker having a drum safety filter (DSF) structure, the 2-way type microspeaker comprising a woofer diaphragm, a first coil positioned between a central portion and boundary of the woofer diaphragm, a main magnet disposed inside the first coil, a sub-magnet installed outside the first coil, and a tweeter diaphragm disposed to face the woofer diaphragm, wherein the microspeaker further comprises a lower support configured to closely press an edge of the tweeter diaphragm, a side plate configured to press the sub-magnet while surrounding an outer surface of the sub-magnet, and an outer casing installed such that a side surface thereof is spaced apart from the side plate and configured such that an end of a bottom thereof bent inside is spaced apart from an outer surface of the lower support and forms an inlet hole of a predetermined size through which high-pressure air is introduced.

6. The 2-way type microspeaker of claim 5, wherein a third split support is installed to occupy at least part of a space between an inner side of the outer casing and an outer side of the side plate while closely surrounding the side plate from an outside, thereby providing a channel through which high-pressure air entered through the inlet hole, an outlet hole of a predetermined size is formed in a side of the outer casing, and the outlet hole is covered with a third ventilation air amount control mesh.

7. The 2-way type microspeaker of claim 1, wherein the microspeaker further comprises an upper housing and an ear cap coupled to the upper housing and configured to provide a sound emission hole, an outflow hole communicating with an outside is formed in one side of the upper housing, and a second ventilation air amount control mesh is installed to cover the outflow hole.

8. The 2-way type microspeaker of claim 2, wherein the microspeaker further comprises an upper housing and an ear cap coupled to the upper housing and configured to provide a sound emission hole, and a woofer grill configured to divide a space of the upper housing and provide a space for mounting hardware is injection-molded to be integrated with a bottom of the upper housing.

9. A 2-way type microspeaker having a drum safety filter (DSF) structure, the 2-way type microspeaker comprising a woofer diaphragm, a first coil positioned between a central portion and boundary of the woofer diaphragm, a main magnet disposed inside the first coil, a sub-magnet installed outside the first coil, and a tweeter diaphragm disposed to face the woofer diaphragm, wherein the 2-way type microspeaker has an appearance formed by an upper casing configured to cover a top of a driver and a lower casing configured to cover a rest of a structure, a woofer diaphragm having a pressed rim is installed between a side rim of the upper casing and an auxiliary ring, a cylindrical lower coil is disposed upward between a central portion and boundary portion of the tweeter diaphragm, and the 2-way type microspeaker further comprises a central support configured such that a top surface thereof comes into contact with an upper part of the main magnet, a center thereof is formed in an empty cylindrical shape, extends downward, and is accommodated inside the lower coil, and a top of the cylinder is covered with a mesh, and a lower support configured to support a bottom surface of the main magnet and also configured such that an outer surface thereof comes into contact with and closes the tweeter diaphragm.

10. The 2-way type microspeaker of claim 9, wherein the 2-way type microspeaker further comprises first and second side supports configured to be successively installed to come into contact with a bottom surface of the lower support plate installed under the woofer diaphragm, a third side support configured to come into contact with an inner side of a top surface of the sub-magnet, a fourth side support configured to be adjacent to the third side support and extend downward to cover all remaining outside of the top surface of the sub-magnet and a side surface of the sub-magnet, and a fifth side support configured such that a top surface thereof comes into contact with a bottom surface of the sub-magnet and a bottom surface thereof comes into contact with a bent bottom surface of the lower casing while covering an outer surface of the lower support.

11. The 2-way type microspeaker of claim 10, wherein the second side support, the fourth side support, and the fifth side support are installed to be spaced apart from the lower casing, and at least the fifth side support is installed to provide a passage by being spaced apart from a center line in a longitudinal direction of a section at a fine interval.

12. The 2-way type microspeaker of claim 10, wherein the 2-way type microspeaker further comprises a support casing configured to press and support an outer surface of the side support, the support casing includes a side surface extending vertically and an upper surface extending outward so as to come into contact with an inner surface of the ear cap from an upper end of the side surface, and an external vent hole configured to discharge high-pressure air is formed in a top surface of the support casing.

13. The 2-way type microspeaker of claim 10, wherein a ventilation block having a predetermined volume is further formed on an inner side of the ear cap, the ventilation block includes a block side surface extending upward to come into contact with and support a side surface of the support casing under the ear cap, and a block top surface horizontally extending to come into contact with and support a top surface of the support casing from a bottom surface at an upper end of the block side surface, and a block identical to the former block is also installed on an opposite side at a predetermined interval from a center line in a longitudinal direction to provide a path through which high-pressure air flows through an overall cut surface.

14. The 2-way type microspeaker of claim 13, wherein a fourth ventilation air amount control mesh is installed over the outer vent hole.

15. A 2-way type microspeaker having a drum safety filter (DSF) structure, the 2-way type microspeaker comprising a woofer diaphragm, a first coil positioned between a central portion and boundary of the woofer diaphragm, a main magnet disposed inside the first coil, a sub-magnet installed outside the first coil, and a tweeter diaphragm disposed to face the woofer diaphragm, wherein a block having a side surface extending upward while pressing the sub-magnet from an outside and a top surface continuing to extend outward from a top of the side surface up to an inner surface of the ear cap is installed, and a ventilation channel configured to penetrate an overall height of the block and communicate to the top surface is formed inside the block.
